(19) United States
(12) Patent Application Publication
(10) Pub. No.: US 2024/0289204 A1
(43) Pub. Date: Aug. 29, 2024

(54) FRAMEWORK TO GENERATE ACTIONABLE AND BUSINESS-RELATED EXPLANATIONS FOR ANOMALY DETECTION PROCESSES

(71) Applicant: Dell Products L.P., Round Rock, TX (US)

(72) Inventors: Adriana Bechara Prado, Niterói (BR); Alexander Eulalio Robles Robles, Valinhos (BR); Eduarda Tatiane Chagas, Belo Horizonte (BR); Isabella Costa Maia, São Paulo (BR); Karen Stéfany Martins, Belo Horizonte (BR)

(21) Appl. No.: 18/175,339

(22) Filed: Feb. 27, 2023

(51) Int. Cl. G06F 11/07

(52) U.S. Cl. CPC G06F 11/079

(57) ABSTRACT

One example method includes receiving data by an anomaly detection model, classifying, by the anomaly detection model, the data as abnormal due to presence of an anomaly in the data, providing the data to an explanation discovery model, generating, by the explanation discovery model, a relative importance of a data feature that is associated with the data, and the relative importance of the data feature indicates an extent to which the anomaly is attributable to the data feature, based in part on the relative importance of the data feature, determining, by a root cause model, a root cause of the anomaly and, when a confidence in the root cause is sufficiently high, returning the root cause to a user in a form that comprises a business-related explanation.

### FIELD OF THE INVENTION

Embodiments of the present invention generally relate to anomaly detection in datasets. More particularly, at least some embodiments of the invention relate to systems, hardware, software, computer-readable media, and methods, for generating business-related explanations for anomalies that have been identified in a dataset.

### BACKGROUND

The application of anomaly detection to the Internet of Things (IoT) industry has been very much explored in recent years and aims at identifying abnormal events in data. The data collected from multiple edge devices, such as sensors for example, of an IoT environment, such as factories, may take the form of a time series. Detecting anomalies in this scenario may be important since, if an edge device experiences a failure, that failure may affect other processes in the environment. In many use cases, in addition to discovering anomalous events, it is also helpful to understand the reasons or causes behind the anomalous events, and which features in the data concerning the anomalous event are mostly related, or most closely related, to the anomaly.

This may mean asking a model for explanations that can give more interpretable, and understandable, information about a prediction, that is, a prediction as to the cause(s) of the anomaly. To achieve this goal, there are several algorithms that may be implemented in a model to obtain explanations of a prediction that are understandable by a layperson.

Some agnostic explainable algorithms, or interpretation models, such as SHAP (SHapley Additive exPlanations) and LIME (Local Interpretable Model-agnostic Explanation) that are based on data perturbation, return an explanation as to the relative importance of each of the features, that is, the features of the data that have the most significant contribution to a data instance that has been identified as an anomaly.

One limitation of this approach is that the understanding of the explanation is limited to experts in the domain, and machine learning (ML) developers who created the model, and, in several applications, those personnel are not the end users. For instance, people who perform factory maintenance might not understand the features and what their importance signifies. Consequently, those people may not be able to identify what is causing the problem, or be able to identify a remedy.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a framework to generate actionable and business-related explanations, according to an embodiment.

FIG. 2 discloses aspects of processes for training an AD model and an ED model, according to an embodiment.

FIG. 3 discloses an overview of an example phase to create root causes, according to an embodiment.

FIG. 4 discloses an overview of an example phase to collect and process new data, according to an embodiment.

FIG. 5 discloses an overview of an example phase in which a root-cause model is created, according to an embodiment.

FIG. 6 discloses the application of an AD model, an ED model, and a root cause model in a production environment, according to an embodiment.

FIG. 7 discloses an example computing entity configured and operable to perform any of the disclosed methods, processes, and operations.

### DETAILED DESCRIPTION OF SOME EXAMPLE EMBODIMENTS

Embodiments of the present invention generally relate to anomaly detection in datasets. More particularly, at least some embodiments of the invention relate to systems, hardware, software, computer-readable media, and methods, for generating business-related explanations for anomalies that have been identified in a dataset.

An embodiment of the invention may comprise a framework to generate actionable and business-related explanations for anomaly detection processes. One particular example embodiment of the invention comprises anomaly detection processes and a framework to generate actionable and business-related explanations. An embodiment may comprise various phases. In a first phase, an anomaly detection (AD) model and an explanation discovery (ED) model are created to, respectively, classify new data as anomalous or not, and return a feature importance for each data feature, that is, the extent to which a particular data feature contributed to, caused, or reflects, the anomaly. The second phase may comprise using a mechanism to generate actionable explanations, with the help of an expert, for anomalous data. In a third phase, more data may be collected that is similar to the anomalous data that has been classified by the expert. After enough data has been collected, an embodiment may, in a fourth phase, create a root-cause model to predict the reasons, or causes, behind an anomaly. In a fifth phase, an embodiment may deploy the root-cause model in production to classify new data and identify new causes for any anomalous data that has been identified. An embodiment may employ a labeling function to translate the actionable explanations, regarding the importance of the various features, into business-related explanations that may be relatively easy for a lay person, or non-expert, to understand.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that explanations of the root causes of anomalous data may be generated that are understandable by persons who are not experts in the field with which that data is concerned. An embodiment may generate information concerning anomalous data that may be used to support business decisions relating the environment in which the anomalous data was collected. Various other advantages of one or more example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

In general, anomaly detection aims at finding patterns in the data that do not follow the expected behavior. There are three main types of anomalies: point; collective; and contextual. A data instance may be a point anomaly if that data instance can be considered anomalous with respect to the rest of the data, that is, the value(s) of the data instance differ compared to the respective values of other data. On the other hand, a collective anomaly considers not only a data instance but a set of related data instances that are anomalous when compared, as a group, to the entire dataset. They may happen only in datasets in which data instances are related, such as sequence, spatial, or graph data. Finally, contextual anomaly considers a data instance that is anomalous in a specific context but not otherwise. So, the context must be specified as a part of the problem. One or more embodiments of the invention may be applied to the three types of anomalies, independent of the anomaly detection model that is being used.

Note that there are many algorithms to explain anomaly detection models. These algorithms may be divided into two categories, namely, self-explaining algorithms, and post-hoc algorithms. Self-explaining algorithms may generate an explanation at the same time as anomaly detection is taking place, using information emitted by the model as a result of the process of making that prediction. In contrast, post-hoc algorithms may require an additional operation to generate the explanation after detecting an anomaly.

Explanations generated by self-explaining algorithms may be local, a justification for a single anomalous instance, or global, a justification for a, potentially large, set of anomalies. Considering the post-hoc algorithms, there are perturbation-based techniques, which may return an explanation in the form of features importance. To do that, the post-hoc algorithm may compute the respective contributions of the features by removing, masking, or altering them, running a forward pass on the new, modified, input, and then measuring the difference with the original input. For instance, LIME and SHAP are considered perturbation-based methods. One or more embodiments of the invention are concerned with explainable algorithms capable of calculating the relative importance of each of one or more features.

That is, it may be useful to generate explanations, along with their root causes, that are easy to understand by any user without limiting the application process. In light of this context, an embodiment of the invention may provide help non-expert users to understand the explanations given by explainable algorithms. As another example, an embodiment may reduce, or eliminate, the significant effort that may typically be involved in translating technical explanations of anomalies into business-related explanations.

In more detail, an embodiment of the invention may assume that there is a database comprised of rows, or ‘instances,’ where each instance is composed of attributes, which may also be referred to herein as ‘features’ or ‘data features.’ For example, and by way of analogy, consider a database where each row represents a computer in a network, and the attributes represent different telemetry measurements relating to a computer, such as memory usage for example. Such a database can serve as the training dataset for a machine learning (ML) algorithm, which will learn what constitutes ‘normal’ behavior of the computer. Particularly, the ML algorithm will then output a machine learning model, such as an anomaly detection system, examples of which are disclosed herein, which will be able to classify, or predict, if a given computer has a ‘normal’ or ‘anomalous’ behavior, given the measurements, or features, of that computer. That is, the anomaly detection model makes a prediction, that is, the anomaly detection model identifies whether the computer has an abnormal behavior, or not.

By using some XAI (explainable AI) algorithms, such as LIME, an embodiment may be able to understand why the anomaly detection system predicted a computer behavior, to continue with the analogy, as being ‘normal’ or ‘anomalous,’ by calculating the importance of each feature, also referred to herein as a ‘feature's importance.’ In this context, the importance of a feature may take the form of a number which may be computed by the XAI algorithm. In general, the higher this number, the greater the influence of the corresponding feature on the prediction. For example, the XAI algorithm may identify that ‘memory usage’ played an important role in the prediction that the computer did, or did not, exhibit anomalous behavior.

In an embodiment, feature importances may serve as explanations for anyone using the anomaly detection system. This type of explanation may be referred to as technical, since it may be understandable to a domain expert, but may not be understandable to a layperson. However, it may be that such technical explanations are not enough to remedy the anomaly. For example, the user of the anomaly detection system may not understand the meaning of the features themselves such as in a case where, for example, there may thousands of different telemetry measurements. Thus, the user may not be able to find a quick solution to the problem that resulted in the anomaly. With this in mind, an embodiment of the invention may operate to translate feature's importances into ‘business-related’ explanations, which are easier to understand by any user of the system, including laypersons, without limiting use of the system. For example, in the aforementioned example, an expert on telemetry data could translate a given set of features' importances into a specific CPU error for the computer.

### B. General Aspects of An Example Embodiment

In general, an embodiment of the invention comprises a pipeline that may include various phases. Example implementations of the phases according to one embodiment are discussed below. The phases may be performed in order, beginning with phase 1 and ending with phase 5.

Phase 1 of an example embodiment may begin with a dataset containing data collected over a period of time. In an embodiment, the data may have been generated by one or more edge devices, but data generated by other data generators may alternatively be employed. Phase 1 may further comprise training an anomaly detection (AD) model to identify each data instance in the dataset as either normal, or anomalous. Finally, this example of phase 1 may comprise training a local explanation discovery (ED) model, such as LIME or SHAP for example, to extract explanations based on the respective importance of one or more features of each data instance.

In an embodiment, phase 2 may begin with a dataset containing anomalous data that was identified as such in phase 1. Next, the ED model, trained in phase 1, may be applied to the dataset to generate an importance-based explanation for the feature(s) of each data instance in the dataset. A clustering algorithm may then be applied to the aforementioned explanations. The clustering process may group the data of the dataset according to their respective similarities, and may return as an output each cluster G={G1, G2, . . . , GN} and its respective centroid C={C1, C2, . . . , CN}.

The groups generated by the clustering process may then be given to an expert, and the expert may analyze, and annotate, the root cause(s) for the anomalies that were identified in the dataset. In an embodiment, the datasets, explanations, and causes, may be stored in a separate database, or respective databases.

Finally, an embodiment may also apply a programmatic labeling algorithm, as another option for the process of annotating, or labeling, the root causes, to capture the insights of the expert concerning the abnormal data and its explanations, and the programmatic labeling algorithm may generate labeling rules to guide the labeling process. That is, another option for the process of annotating, or labeling, the root causes for each cluster would be the application of programmatic labeling algorithms. So, instead of applying the clustering algorithm, an embodiment may apply programmatic labeling to generate the root causes. The cluster algorithm and programmatic labeling are independent of each other. For the cluster algorithm, the root causes may be created using the clusters. And, for programmatic labeling, the root causes may be created using the labeling rules.

In Phase 3 of an embodiment, more data may be collected, and the AD model (trained at phase 1) used to identify anomalies. Then, the ED model (also trained in phase 1) may be used to generate features' importance explanation for each of the anomalous data instances.

For each anomalous instance, an embodiment may then calculate the distance between the instance and each centroid C (from the clusters constructed at phase 2), selecting the smallest distance. If the smallest distance is less than a defined threshold, an embodiment may return, to the user, a root-cause associated with the centroid that yields the smallest distance. On the other hand, if the smallest distance is greater than a defined threshold, an instance may be added to dataset and return to phase 2 so that the expert can identify the new root cause, and the centroids can be recalculated. As well, the number of clusters may then be incremented by one. Finally, in the case that labeling rules were generated using programmatic labeling, the anomalous instance(s) may be automatically labeled.

In phase 4 of an example embodiment, after M instances have been collected for each identified cause in phase 2, an embodiment may train a classifier to obtain abnormal data, and the corresponding explanations, as input, and the model may then return the corresponding root cause of the abnormal data.

Phase 5 of an example embodiment may comprise a production, or online, stage, while phases 1 through 4 may collectively define an offline, or training, stage of an embodiment. In production, the AD model may identify an anomaly in a dataset. The ED model may then be applied to generate an explanation for the anomaly, and the root cause classifier may be applied to the anomaly and return a corresponding cause for the anomaly. If the root cause classifier returns the cause with a confidence higher than a defined threshold, the identified cause may be returned to the user. Otherwise, an embodiment may return to phase 2 so that the expert can identify the new cause of the anomaly.

### C. Detailed Discussion

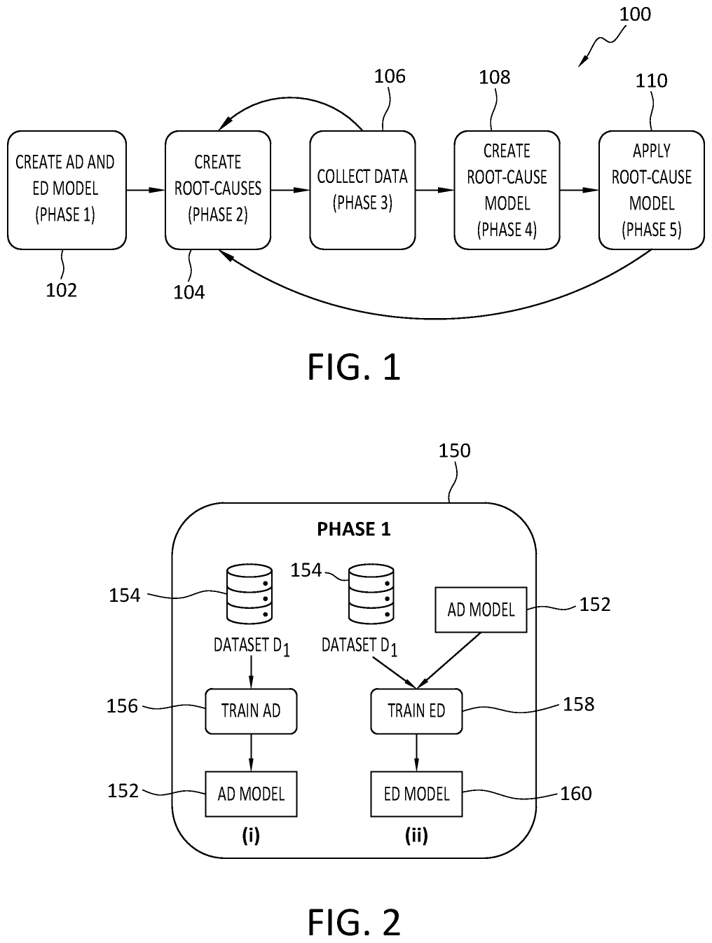

One embodiment of the invention may be concerned with anomaly detection processes, and may comprise a framework to generate actionable and business-related explanations. With attention now to FIG. 1, there is disclosed an overview of an embodiment of a framework 100, comprising various phases, to generate actionable and business-related explanations. Particularly, in a first phase 102, an anomaly detection (AD) model and an explanation discovery (ED) model may be created to, respectively, classify new data, and return a feature contribution for each new piece of data. In an embodiment, an expert may help to classify the data at 102. In a second phase 104, an embodiment may employ a mechanism to generate various actionable explanations, possibly with the help of an expert. At a third phase 106, an embodiment may collect more data similar to the data that was classified by the expert at 104. When enough data has been collected, an embodiment may, in a fourth phase 108, create a root-cause model that is configured and operable to predict the reasons behind an anomaly, such as any anomaly detected at 102. Finally, at a fifth phase 110, an embodiment may deploy the root-cause model in production to classify new data and identify new causes for anomalies identified in that new data. Further details concerning each of the phases of an example embodiment are provided hereafter.

### C.1 Example Phase 1

With attention now to FIG. 2, there is disclosed an overview of an example of a phase 1. In general, phase 1 may [1] collection of a time series dataset and training an anomaly detection model to detect an anomaly, and [2] using the dataset and the anomaly detection (AD) model to generate an explainable model.

In an embodiment, a first phase 150 comprises building the initial AD model 152. The AD model 152 may be capable of distinguishing between normal data, and abnormal, or anomalous, data. Thus, during an initial training process, an embodiment may collect a time series dataset 154 D1, that is, a dataset whose constituent data is acquired over a period of time. Then, an embodiment may train 156 the initial AD model using the time series dataset 154 D1. To train 156 the AD model, an embodiment may use a supervised approach, if labeled data is available, or an unsupervised approach, such as clustering-based models, if labeled data is not available.

After creating the AD model 152, an embodiment may use the time series dataset 154 D1 and the AD model 152 itself to create and train 158 an explanation discovery (ED) model 160. The ED model 160, which may comprise a SHAP or LIME model, may be operable to extract features' importance for each data instance, that is, the extent to which each data feature is contributing to a prediction that the data is anomalous, or not.

### C.2 Example Phase 2

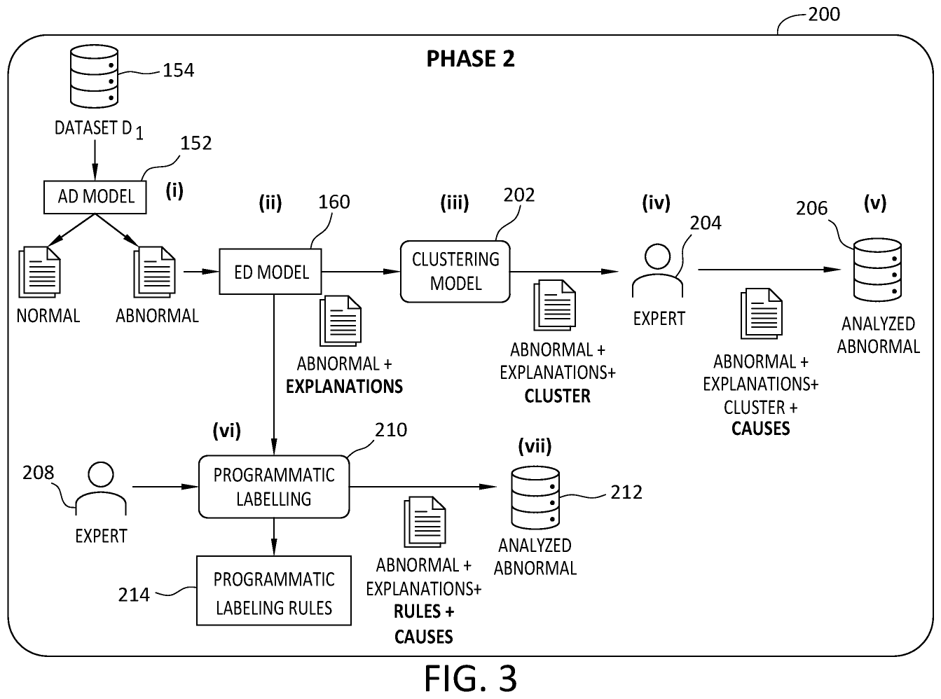

With attention now to FIG. 3, there is disclosed an example second phase 200 according to one embodiment. Following is a brief overview of an embodiment of the second phase 200. In general, an embodiment may comprise the operations: [i] apply the AD model to the dataset; [ii] apply the ED model to the dataset; [iii] create a clustering model to group the data; [iv] expert analysis and classification of each group of data; [v] saving the data in a repository; [vi] instead of creating a cluster model, as at [iii], an embodiment may apply programmatic labeling to generate labeling rules also with the help of an expert; and [vii] saving the data generated by the programmatic labeling.

In more detail, and with continued reference to the example of FIG. 3, after training initial AD and ED models, as shown in FIG. 2, an embodiment may apply the AD model to the D1 dataset to predict, or distinguish, between normal and abnormal data. Then, an embodiment may apply the ED model to the abnormal data to generate the importance of the features of the abnormal data. Next, the clustering model or algorithm, such as K-means clustering, may be applied to the data. The clustering model is responsible for grouping the explanations based on their similarities. To perform this clustering, a clustering model 202 may receive both features and their relative importance generated by the ED model, and may return each cluster G={G1, G2, . . . , GN} and the respective centroids of the clusters, namely, C={C1, C2, . . . , CN}. After consolidating each cluster, an expert 204 may analyze each of the clusters to understand the reasons behind the explanations in the clusters. Then, the expert 204 may annotate the root causes associated with the explanations in each cluster, which can be a written textual explanation, and/or more features that explain the problem, R={R1, R2, . . . , RN}. Finally, an embodiment may save the anomaly, its features' importance, and the root causes in the analyzed abnormal dataset 206.

Another approach to the process of annotating, or labeling, the root causes for each cluster may be the application of programmatic labeling algorithms. In this approach, an embodiment may provide the explanations, or features' importance, to a human expert 208 who may produce, possibly noisy, labeling functions. In this context, a labeling function may comprise a set of rules that will describe how an embodiment may translate a set of feature importance-based explanations into business-related explanations.

To reduce noise and/or facilitate the automatic conflict resolution of the labeling process, an embodiment may use a data programming pipeline, or programmatic labeling 210, such as the one proposed in Cohen-Wang, Benjamin, et al. “Interactive programmatic labeling for weak supervision.” Proc. KDD DCCL Workshop. Vol. 120. 2019 (which is incorporated herein in its entirety by this reference), in which implicit generative models are used to weight and combine the outputs of the labeling functions, which may overlap and disagree with each other. Based on the output of generative models, discriminative models may be used to provide the final causes for each sample of data, and the data analyzed as abnormal stored in an analyzed abnormal dataset 212.

By opting for the use of programmatic labeling, as in one embodiment, the business-related cause labeling process may become automatic, scalable, easy to track and adaptable to drift scenarios. To facilitate the construction of labeling functions, which may comprise one or more programmatic labeling rules 214, an embodiment may use a percentage of the most representative samples using clustering algorithms. For this, an embodiment may find the labeling functions for the centroids and samples present in a certain pre-defined radius. Thus, at the end of this process, there may be found, for each anomaly, and given the importance of the features, the labeling functions for finding the business-related root cause explanations.

### C.3 Example Phase 3

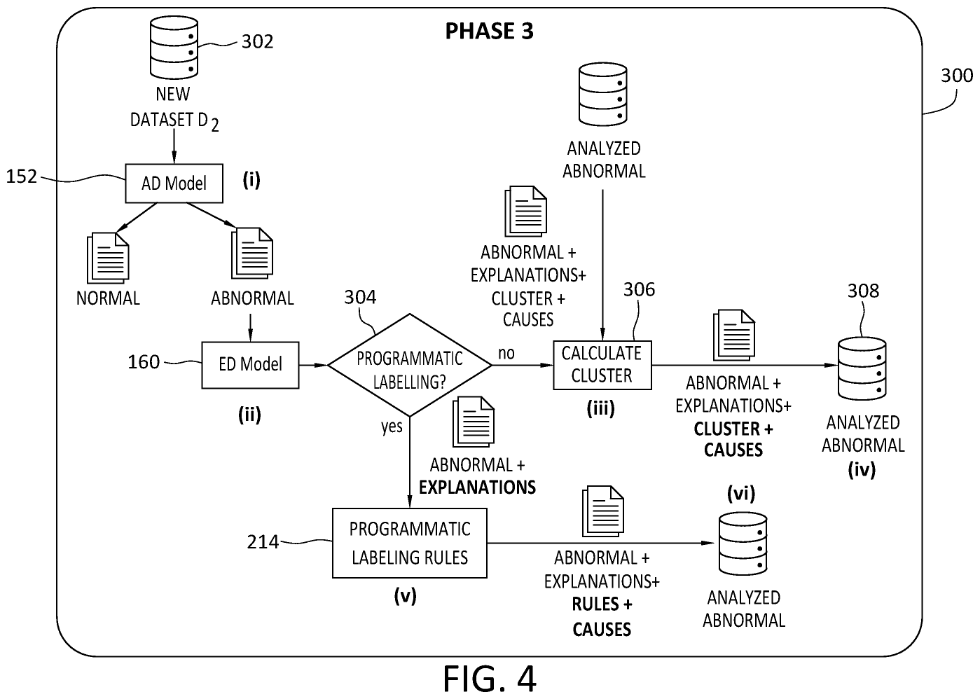

With attention now to FIG. 4, there is disclosed an example third phase 300 according to one embodiment. Following is a brief overview of an embodiment of the third phase 300. In general, an embodiment may comprise the operations: [i] apply the AD model to the dataset; [2] apply the ED model in the dataset; [3] for each instance, calculate its cluster; [iv] save the new data with its explanations, cluster, and root-causes, in a repository; [v] as an alternative to calculating the cluster, as at [3], apply the programmatic labeling rules; and [vi] save the new data with its explanations, rules, and root causes, in a repository.

In more detail, and with continued reference to the example of FIG. 4, an embodiment may, in this third phase, collect more data and apply the clustering, or programmatic labeling, approach to identify root causes for identified anomalies in the data. Thus, an embodiment may first collect a new dataset 302 D2 different from D1. Then, an embodiment may apply the AD model 152 and the ED model 160 created in phase 1 to identify, respectively, the abnormal data, and the explanations for the abnormal data.

If a decision 304 is made to use a clustering model, rather than programmatic labeling, in the second phase 200, there may be a need to associate the correct cluster to each instance. To do that, an embodiment may calculate 306 the distance between the instance and each centroid in C. Then, an embodiment may select the centroid with the smallest distance ds. If ds is less than a defined threshold t, ds<t, an embodiment may save, in an analyzed abnormal dataset 308, the abnormal data, the respective explanations for the abnormal data, the clusters Gj that include the abnormal data, and the respective root causes Rj for the abnormal data.

However, if ds is greater than the defined threshold t, ds>t, it means that the explanation do not belong to any of the clusters in C, and so the expert may have to identify the new root cause and recalculate the centroids. So, in this case, the method according to one embodiment may return to the second phase 200, and increment the number of clusters by one.

On the other hand, if a decision 304 is made to apply programmatic labeling, an embodiment may have a set of unlabeled dataset 302 D2 samples that follow the same rules mapped previously by a human expert using the dataset 154 D1. Therefore, to perform the automatic labeling, an embodiment may use the previously trained model to obtain the final labels, and treat cases where there will be divergences between the functions. Thus, such a model may receive, as input, the set of labeling functions mapped previously, and the new sample, and may then provide the most suitable label, which in this case may be the set of business-related root causes. On samples not previously mapped by the function set, the model may abstain at labeling time.

### C.4 Example Phase 4

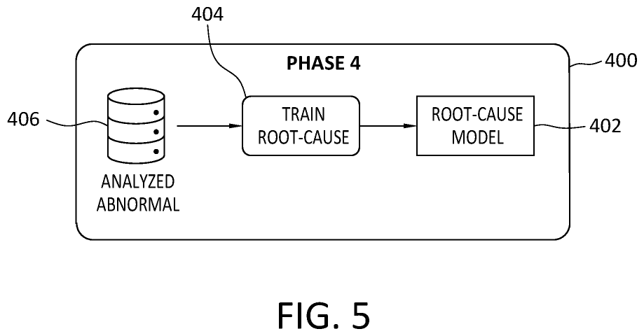

With attention now to FIG. 5, there is disclosed an example fourth phase 400 according to one embodiment. In general, an embodiment may train a root-cause model to predict root-causes on new data. More particularly, a root cause model 402 may be trained 404 using data 406 analyzed as being abnormal, that is, anomalous. In this phase, the root cause model 402 may receive the abnormal data the features of the abnormal data, the respective importance of those features and their root causes, where all this input is collectively denoted at 406, and the root cause model 402 may then return the root cause(s) for the anomalous data. To that end, an embodiment may use the collected data in the analyzed abnormal dataset 406 and create a supervised classifier model, that is, the root-cause model 402, using the root-cause as a target. In an embodiment, at least m examples of each root cause are collected in the third phase before starting the training 404, so as to avoid an unbalanced dataset.

### C.5 Example Phase 5

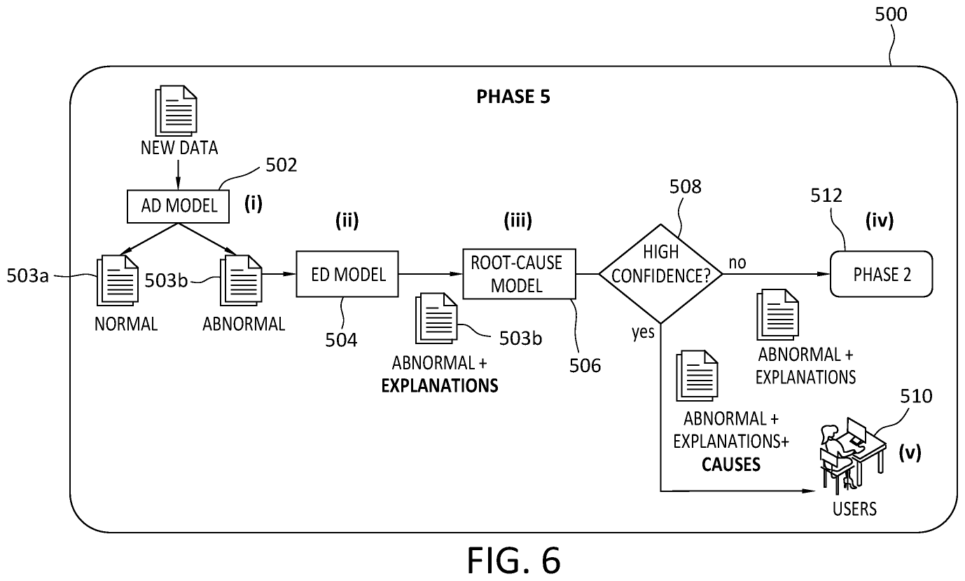

With attention now to FIG. 6, there is disclosed an example fifth phase 500, in which a model is deployed in a production, or online, setting, according to one embodiment. Following is a brief overview of an embodiment of the fifth phase 500. In general, an embodiment may comprise the operations: [i] apply the AD model in the dataset; [ii] apply the ED model to the dataset; [iii] classify the new data with the root-cause model; [iv] if the confidence is lower than a defined threshold, return to the second phase; and [v] otherwise, return the root cause of the anomalous data to the end user.

In more detail, and with continued reference to the example of FIG. 6, an embodiment may, in this fifth phase, deploy the AD model 502, ED model 504, and root-cause model 506, in production. New data may be classified as normal 503a or abnormal 503b by the AD model 502. If the AD model 502 indicates data is abnormal, an embodiment may then apply the ED model 504 to generate the relative importance, that is, explanations, of the various features of the abnormal data. Then, an embodiment may apply the root cause model 506 to determine the reasons behind the anomaly. If the confidence c returned by the model, that is, the confidence that the reason(s) behind the anomaly has/have been correctly determined, is determined 508 to be higher than a defined threshold t2, c>t2, an embodiment may return the root cause to the final users. Otherwise, if the confidence c is determined 508 to be lower than the threshold t2, c<t2, an embodiment may return 512 the new data to phase 2, so an expert can identify the new root cause for the anomalous data, and recalculate the centroids of the new/modified clusters that include the new data.

### D. Further Discussion

As will be apparent from this disclosure, example embodiments of the invention may possess various aspects and useful features. Following is a non-exhaustive list of some of such aspects and features.

For example, an embodiment may implement a pipeline to generate more tangible and actionable explanations, of anomalous data, for non-expert users, transforming automatically generated technical explanations into business-related explanations that may be more understandable by a layperson. Most explainable algorithms return an explanation that is only accessible to experts and machine learning developers, which makes the explanation inaccessible for the end users. Thus, an embodiment comprises an approach focused on final users, where the explanation is easy to understand.

As another example, an embodiment may operate to reduce the efforts required by experts by using a weakly supervised approach. Since most explanations are restricted to experts, they usually spend a considerable time to analyze the explanations. Thus, an embodiment may use the expert knowledge to create an automatic approach to reduce their effort when dealing with new data.

Further, an embodiment may provide for the exploitation of the prior information from the experts in order to create new, supervised, models that may have more accurate and rich information. Particularly, an embodiment may automate the expert efforts by using their knowledge to create a supervised model capable of identifying root causes on new anomalous data, thus facilitating utilization of the explanations by an end user.

As a final example, an embodiment of the invention may apply programmatic labeling algorithms to build more business-related explanations in data anomaly detection processes. Particularly, instead of annotating a large number of instances, an embodiment may apply programmatic labeling to annotate a smaller number of instances, and then propagate the labels to similar instances.

### E. Example Methods

It is noted with respect to the disclosed methods, including the example methods of FIG. 1-6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are

presented only by way of example and are not intended to limit the scope of the invention in any way.

Embodiment 1. A method, comprising: receiving data by an anomaly detection model; classifying, by the anomaly detection model, the data as abnormal due to presence of an anomaly in the data; providing the data to an explanation discovery model; determining, by the explanation discovery model, a relative importance of a data feature that is associated with the data, and the relative importance of the data feature indicates an extent to which the anomaly is attributable to the data feature; based in part on the relative importance of the data feature, determining, by a root cause model, a root cause of the anomaly; and when a confidence that the root cause has been correctly identified is higher than a defined threshold, returning the root cause to an end user in a form that comprises a business-related explanation of the root cause.

Embodiment 2. The method as recited in any preceding embodiment, wherein data received by the anomaly detection model that is not classified as abnormal is not passed to the explanation discovery model.

Embodiment 3. The method as recited in any preceding embodiment, wherein when the confidence is equal to, or less than, the defined threshold, the data is returned to an expert for a determination of a new root cause of the anomaly.

Embodiment 4. The method as recited in any preceding embodiment, wherein the anomaly detection model was trained using training data, and the data received by the anomaly detection model comprises production data.

Embodiment 5. The method as recited in any preceding embodiment, wherein the root cause was labeled as such by a label created by a programmatic labeling algorithm or a clustering algorithm.

Embodiment 6. The method as recited in any preceding embodiment, wherein the anomaly is one of: a point anomaly; a collective anomaly; or, a contextual anomaly.

Embodiment 7. The method as recited in any preceding embodiment, wherein the explanation discovery model was trained using the anomaly detection model, and using data that was used to train the anomaly detection model.

Embodiment 8. The method as recited in any preceding embodiment, wherein the anomaly detection model was trained using a time series dataset.

Embodiment 9. The method as recited in any preceding embodiment, wherein when the confidence is equal to, or less than, the defined threshold, the data is clustered as part of a process to identify a new root cause.

Embodiment 10. The method as recited in any preceding embodiment, wherein when the confidence is equal to, or less than, the defined threshold, a programmatic labeling process is applied to the data to identify a new root cause.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

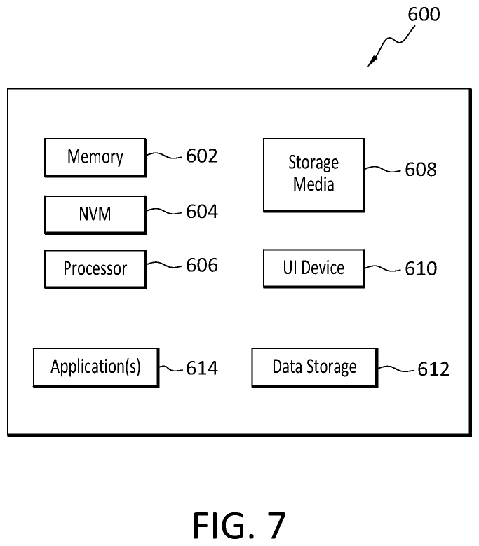

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 7.

In the example of FIG. 7, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving data by an anomaly detection model;
classifying, by the anomaly detection model, the data as abnormal due to presence of an anomaly in the data;
providing the data to an explanation discovery model;
determining, by the explanation discovery model, a relative importance of a data feature that is associated with the data, and the relative importance of the data feature indicates an extent to which the anomaly is attributable to the data feature;
based in part on the relative importance of the data feature, determining, by a root cause model, a root cause of the anomaly; and
when a confidence that the root cause has been correctly identified is higher than a defined threshold, returning the root cause to an end user in a form that comprises a business-related explanation of the root cause.

2. The method as recited in claim 1, wherein data received by the anomaly detection model that is not classified as abnormal is not passed to the explanation discovery model.

3. The method as recited in claim 1, wherein when the confidence is equal to, or less than, the defined threshold, the data is returned to an expert for a determination of a new root cause of the anomaly.

4. The method as recited in claim 1, wherein the anomaly detection model was trained using training data, and the data received by the anomaly detection model comprises production data.

5. The method as recited in claim 1, wherein the root cause was labeled as such by a label created by a programmatic labeling algorithm or a clustering algorithm.

6. The method as recited in claim 1, wherein the anomaly is one of: a point anomaly; a collective anomaly; or, a contextual anomaly.

7. The method as recited in claim 1, wherein the explanation discovery model was trained using the anomaly detection model, and using data that was used to train the anomaly detection model.

8. The method as recited in claim 1, wherein the anomaly detection model was trained using a time series dataset.

9. The method as recited in claim 1, wherein when the confidence is equal to, or less than, the defined threshold, the data is clustered as part of a process to identify a new root cause.

10. The method as recited in claim 1, wherein when the confidence is equal to, or less than, the defined threshold, a programmatic labeling process is applied to the data to identify a new root cause.

11. A non-transitory storage medium having stored therein instructions that are executable by one or more hardware processors to perform operations comprising:
receiving data by an anomaly detection model;
classifying, by the anomaly detection model, the data as abnormal due to presence of an anomaly in the data;
providing the data to an explanation discovery model;
determining, by the explanation discovery model, a relative importance of a data feature that is associated with the data, and the relative importance of the data feature indicates an extent to which the anomaly is attributable to the data feature;
based in part on the relative importance of the data feature, determining, by a root cause model, a root cause of the anomaly; and
when a confidence that the root cause has been correctly identified is higher than a defined threshold, returning the root cause to an end user in a form that comprises a business-related explanation of the root cause.

12. The method as recited in claim 1, wherein data received by the anomaly detection model that is not classified as abnormal is not passed to the explanation discovery model.

13. The method as recited in claim 1, wherein when the confidence is equal to, or less than, the defined threshold, the data is returned to an expert for a determination of a new root cause of the anomaly.

14. The method as recited in claim 1, wherein the anomaly detection model was trained using training data, and the data received by the anomaly detection model comprises production data.

15. The method as recited in claim 1, wherein the root cause was labeled as such by a label created by a programmatic labeling algorithm or a clustering algorithm.

16. The method as recited in claim 1, wherein the anomaly is one of: a point anomaly; a collective anomaly; or, a contextual anomaly.

17. The method as recited in claim 1, wherein the explanation discovery model was trained using the anomaly detection model, and using data that was used to train the anomaly detection model.

18. The method as recited in claim 1, wherein the anomaly detection model was trained using a time series dataset.

19. The method as recited in claim 1, wherein when the confidence is equal to, or less than, the defined threshold, the data is clustered as part of a process to identify a new root cause. 20 The method as recited in claim 1, wherein when the confidence is equal to, or less than, the defined threshold, a programmatic labeling process is applied to the data to identify a new root cause.
